(19) United States
(12) Patent Application Publication
(10) Pub. No.: US 2026/0349198 A1
(43) Pub. Date: Nov. 5, 2026

(54) OPTICAL DEVICE

(71) Applicant: FURUKAWA ELECTRIC CO., LTD., Tokyo (JP)

(72) Inventors: Ryo OTSUBO, Tokyo (JP); Takashi MOGI, Tokyo (JP); Yozo ISHIKAWA, Tokyo (JP)

(73) Assignee: FURUKAWA ELECTRIC CO., LTD., Tokyo (JP)

(21) Appl. No.: 19/722,128

(22) Filed: Jun. 26, 2026

Related U.S. Application Data
(63) Continuation of application No. PCT/JP2025/003032, filed on Jan. 30, 2025.

(30) Foreign Application Priority Data
Feb. 9, 2024 (JP) 2024-018913

(51) Int. Cl. G02B 6/42

(52) U.S. Cl. CPC G02B 6/4248; G02B 6/424

(57) ABSTRACT

An optical device includes a supporting member that is integrated with a housing while protruding from the housing, and that has an opening formed therein for allowing passage of an optical fiber; an encapsulant that, inside the opening of the supporting member, is present between the supporting member and the optical fiber; a first covering member that encloses the optical fiber; and a second covering member that encloses the first covering member; and a fixing member that joins and integrates the supporting member and the first covering member. Along the optical fiber, a first section is provided in which only the first covering member encloses the covering, and a second section is provided which is adjacent to the side close to the supporting member with reference to the first section and in which only the first covering member and the second covering member enclose the optical fiber.

This application is a continuation of International Application No. PCT/JP2025/003032, filed on Jan. 30, 2025 which claims the benefit of priority of the prior Japanese Patent Application No. 2024-018913, filed on Feb. 9, 2024, the entire contents of which are incorporated herein by reference.

### BACKGROUND

The present disclosure relates to an optical device.

Conventionally, a structure is known by which, in the portion in which an optical fiber passes through the housing of an optical device, the optical fiber is protected by enclosing it in a tube, a protection sleeve, or a fiber connector boot (for example, refer to International Publication Pamphlet No. WO 2021/132681). In International Publication Pamphlet No. WO 2021/132681, a plurality of components meant for covering the optical fiber is inserted into the pipe protruding from the housing.

### SUMMARY

In a configuration in which a plurality of components is inserted into the pipe as disclosed in International Publication Pamphlet No. WO 2021/132681, the size of the pipe increases and in turn the size of the optical device increases, which leads to a risk of failing to meet the requirement of configuring a compact optical device.

There has been a demand for a new and improved optical device that can be configured in a more compact manner.

According to an aspect of the embodiment of the present disclosure, there is provided an optical device including: a housing; an optical fiber that extends from inside of the housing to outside of the housing; a supporting member that is integrated with the housing while protruding from the housing, and that has a first opening formed therein for allowing passage of the optical fiber; an encapsulant that, inside the first opening of the supporting member, is present between the supporting member and the optical fiber; a first covering member that, in state of either remaining in contact with or being positioned with a gap from at least some portion of a covering of the optical fiber on outside of the housing and outside of the first opening, encloses the optical fiber; a second covering member that, while remaining in contact with the first covering member, encloses the first covering member; and a fixing member that joins and integrates the supporting member and the first covering member, wherein along the optical fiber, a first section is provided in which only the first covering member encloses the covering, and a second section is provided which is adjacent to side close to the supporting member with reference to the first section and in which only the first covering member and the second covering member enclose the optical fiber.

The above and other features, advantages and technical and industrial significance of this disclosure will be better understood by reading the following detailed description of presently preferred embodiments of the disclosure, when considered in connection with the accompanying drawings.

It is to be understood that both the foregoing general description and the following detailed description are exemplary and explanatory and are not restrictive of the disclosure, as claimed.

### BRIEF DESCRIPTION OF THE DRAWINGS

FIG. 1 is an illustrative and schematic perspective view of an optical device according to a first embodiment;

FIG. 2 is an illustrative and schematic cross-sectional view of the optical device according to the first embodiment;

FIG. 3 is an illustrative and schematic cross-sectional view of the optical device according to the first embodiment, and is an intersecting cross-sectional view to FIG. 2;

FIG. 4 is a cross-sectional view at IV-IV position illustrated in FIG. 3;

FIG. 5 is a cross-sectional view at V-V position illustrated in FIG. 3;

FIG. 6 is an illustrative and schematic cross-sectional view that, in the state in which a bending input is input with respect to the optical fiber, illustrates some portion of the optical device at the equivalent position to the position illustrated in FIG. 3;

FIG. 7 is an illustrative and schematic perspective view of some portion of a supporting member according to a second embodiment;

FIG. 8 is an illustrative and schematic perspective view of some portion of a supporting member according to a third embodiment;

FIG. 9 is an illustrative and schematic perspective view of some portion of a supporting member according to a fourth embodiment;

FIG. 10 is an illustrative and schematic perspective view of some portion of a supporting member according to a fifth embodiment;

FIG. 11 is an illustrative and schematic perspective view of some portion of a supporting member according to a sixth embodiment;

FIG. 12 is an illustrative and schematic cross-sectional view of an optical device according to a seventh embodiment at the equivalent position to the position illustrated in FIG. 2;

FIG. 13 is an illustrative and schematic perspective view of an enclosure member included in the optical device according to the seventh embodiment;

FIG. 14 is an illustrative and schematic perspective view of an enclosure member included in an optical device according to an eighth embodiment;

FIG. 15 is an illustrative and schematic perspective view of an enclosure member included in an optical device according to a ninth embodiment;

FIG. 16 is an illustrative and schematic perspective view of an optical device according to a 10-th embodiment;

FIG. 17 is an illustrative and schematic perspective view of the optical device according to the 10-th embodiment; and

FIG. 18 is a cross-sectional view at XVIII-XVIII position illustrated in FIG. 17.

### DETAILED DESCRIPTION

The configurations explained in the embodiment described below as well as the actions and the results (effects) attributed to the configurations are only exemplary. Thus, the present disclosure can be implemented also using some different configuration than the configurations disclosed in the embodiments described below. Meanwhile, according to the present disclosure, it becomes possible to achieve at least one of various effects (including secondary effects) that are attributed to the configurations.

The embodiments described below include identical constituent elements. Thus, based on the identical configuration according to each embodiment, it becomes possible to achieve identical actions and identical effects. In the following explanation, the identical constituent elements are referred to by the same reference numerals, and their explanation is not given in a repeated manner.

In the present written description, ordinal numbers are assigned only for convenience and with the aim of differentiating among the components and the parts. Thus, the ordinal numbers do not indicate the priority or the sequencing.

The drawings are schematic in nature, and the shapes and dimensions may be different than the actual situation. In the drawings, the X direction is indicated by an arrow X, the Y direction is indicated by an arrow Y, and the Z direction is indicated by an arrow Z. The X direction, the Y direction, and the Z direction intersect with each other and are orthogonal to each other.

### First Embodiment

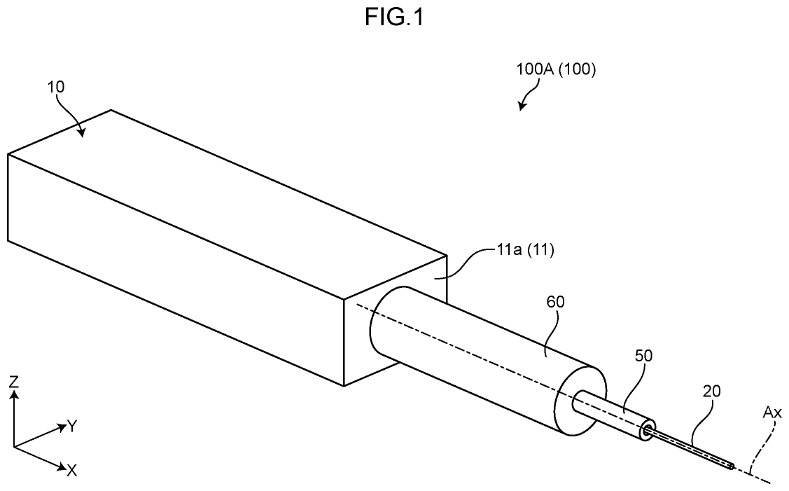

FIG. 1 is a perspective view of an optical device 100A (100) according to a first embodiment. The optical device 100 includes a housing 10, an optical fiber 20, a first covering member 50, and a second covering member 60.

As an example, the housing 10 has an external appearance of a cuboid shape elongated in the X direction. Inside the housing 10 are housed components such as optical components and electrical components. The optical components are optically connected to the fiber core. With reference to the configuration illustrated in FIG. 1, the X direction is also called the longitudinal direction; the Y direction is also called the width direction; and the Z direction is also called the thickness direction. Meanwhile, the overall shape of the housing 10 (the optical device 100) is not limited to the shape illustrated in FIG. 1.

The housing 10 has a wall 11 that separates the inside of the housing 10 from the outside. The wall 11 can be made of different materials depending on its positions. For example, the wall 11 can have a portion made of a material having high thermal conductivity, such as copper tungsten (CuW), copper molybdenum (CuMo), or aluminum oxide (Al₂O₃); and can have a portion made of a material having a low thermal expansion coefficient, such as an Fe—Ni—Co alloy or aluminum oxide (Al₂O₃).

The optical fiber 20 includes the fiber core in which a core and a cladding are included, and includes a covering that encloses the fiber core. The optical fiber 20 passes through the wall 11 of the housing 10, and extends from the inside of the housing 10 to the outside of the housing 10.

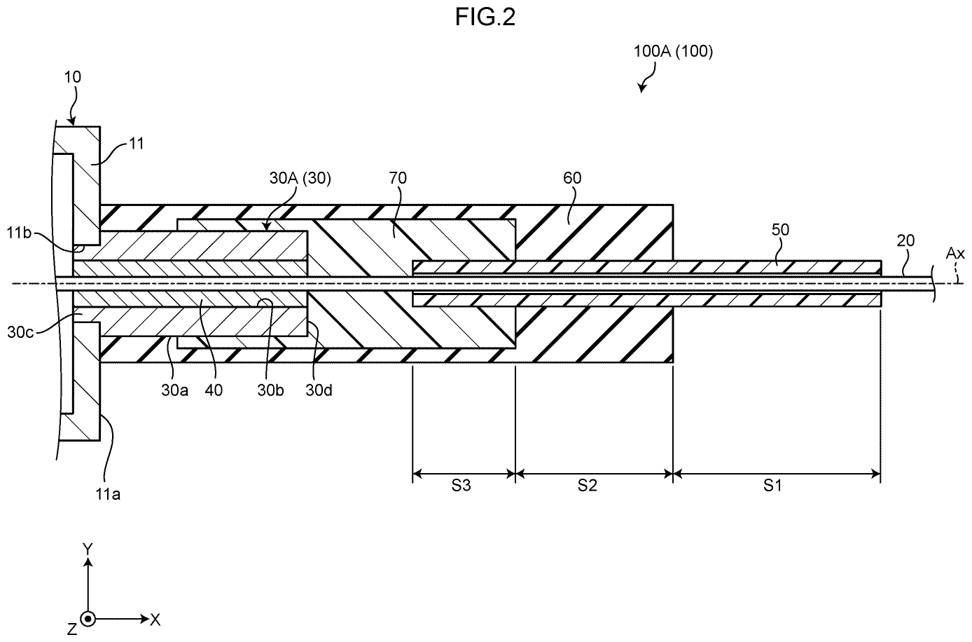

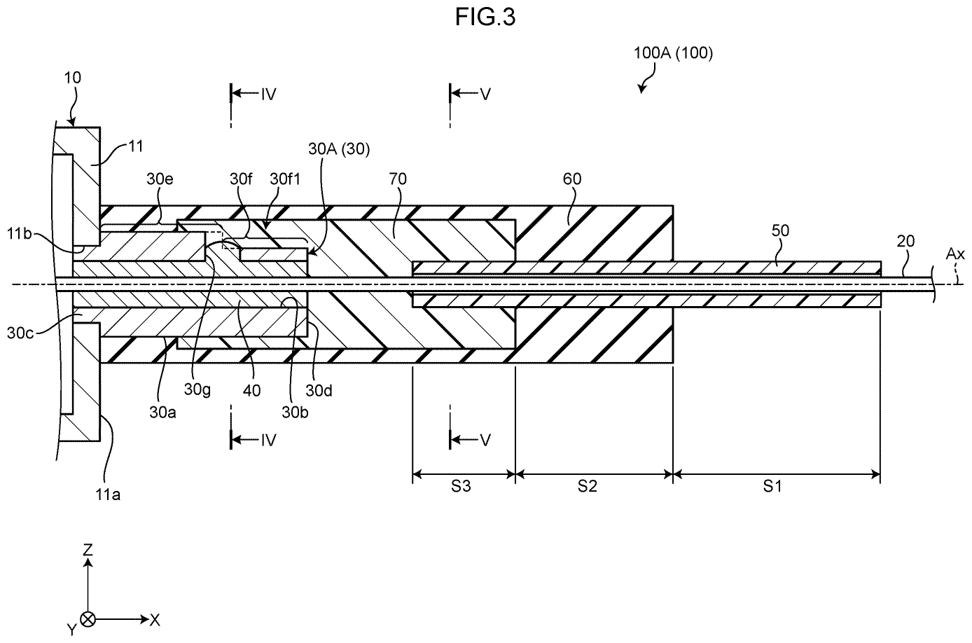

FIG. 2 is a cross-sectional view of a cross-section of the optical device 100A intersecting with the Z direction. FIG. 3 is a cross-sectional view of a cross-section of the optical device 100A intersecting with the Y direction.

As illustrated in FIGS. 2 and 3, the optical device 100A further includes a supporting member 30A (30), an encapsulant 40, and a fixing member 70.

### Supporting Member and Encapsulant

The supporting member 30A is integrated with the housing 10. The supporting member 30A protrudes from a face 11a of the wall 11, on which an opening 11b is formed to allow passage of the optical fiber 20, along the direction of passage of the optical fiber 20, that is, along the X direction.

In the first embodiment, as an example, the supporting member 30A has a boss section that is partially inserted into the opening 11b formed on the wall 11 at an end portion 30c. The supporting member 30A is configured as a separate component from the housing 10 and is joined to the housing 10 by means of brazing. The supporting member 30A can be made of a material having a low thermal expansion coefficient, such as an Fe—Ni—Co alloy or aluminum oxide (Al₂O₃). However, the supporting member 30 is not limited to have such a structure. Alternatively, for example, the supporting member 30 can pass through the opening 11b, or can be fixed onto the face 11a without including a boss section and without being partially inserted into the opening 11b. Moreover, the supporting member 30 need not be a separate component from the housing 10, and can alternatively represent a part of the housing 10 protruding from the wall 11.

The supporting member 30A has a substantially cylindrical shape on the whole, and includes an outer surface 30a having the shape of a cylindrical outer surface.

The supporting member 30A has an opening 30b formed therethrough in the X direction; and the optical fiber 20 passes through the opening 30b in the X direction. The opening 30b has the shape of a cylindrical inner surface. The opening 30b represents an example of a first opening through which the optical fiber 20 passes.

The supporting member 30A has an end face 30d in the X direction. The end face 30d is positioned at the end portion on the opposite side of the housing 10, that is, at the end portion in the X direction. The end face 30d intersects with the X direction as well as is orthogonal to the X direction, and is an annular face oriented in the X direction.

The encapsulant 40 is present in between the inner face of the opening 30b and the outer surface of the optical fiber 20. The encapsulant 40 enables fixing the optical fiber 20 to the supporting member 30A. Moreover, the encapsulant 40 enables hermetic sealing between the inner face of the opening 30b and the optical fiber 20. The covering of the optical fiber 20 is removed inside the opening 30b. That is, the encapsulant 40 enables hermetic sealing between the inner face of the opening 30b and the outer surface of the fiber core of the optical fiber 20. Examples of the encapsulant 40 include, but are not limited to, a solder. Meanwhile, a central axis Ax illustrated in FIGS. 1 to 3 represents the central axis of the opening 30b. Moreover, with reference to FIGS. 1 to 3, the central axis of the optical fiber 20 is coincident with the central axis Ax of the opening 30b. However, the two central axes need not be coincident.

As illustrated in FIG. 3, the supporting member 30A includes a first supporting portion 30e present on the side close to the housing 10, and includes a second supporting portion 30f present on the side opposite to the housing 10 with reference to the first supporting portion 30e.

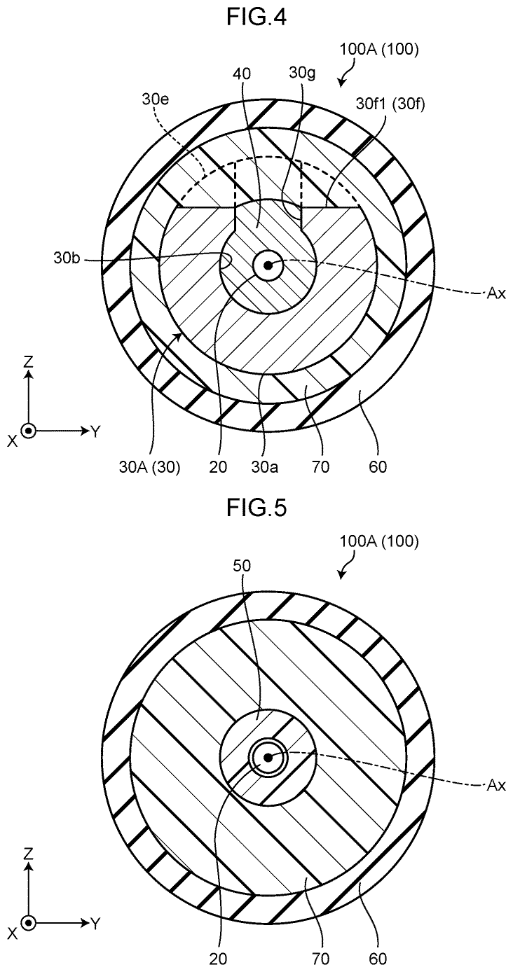

FIG. 4 is a cross-sectional view at IV-IV position illustrated in FIG. 3. As illustrated in FIGS. 2, 3, and 4, the first supporting portion 30e has a cylindrical shape. In the second supporting portion 30f, a notch 30f1 is formed by cutting out some portion of the cylindrical outer surface 30a; and the thickness of the second supporting portion 30f in a direction intersecting with the axial direction of the central axis Ax (i.e., in a direction intersecting with the X direction) (i.e., the thickness of the second supporting portion 30f in the Z direction) is smaller than the thickness of the first supporting portion 30e. The cross-section of the second supporting portion 30f intersecting with the central axis Ax is a substantially D-shaped cross-section. Meanwhile, the notch 30f1 can also be called a depression.

Moreover, as illustrated in FIG. 3, an opening 30g is formed at the boundary between the first supporting portion 30e and the second supporting portion 30f of the supporting member 30A. The opening 30g is connected to the opening 30b and extends at least in the direction intersecting with the axial direction of the central axis Ax of the opening 30b (i.e., intersecting with the X direction). In the first embodiment, the opening 30g is a through hole extending in the Z direction. The opening 30g is used as the conduit or the inlet for pouring the encapsulant 40, which is in the fluid state prior to becoming solid, into the opening 30b. The encapsulant 40 in the fluid state is poured from the open end of the opening 30g which is farther from the opening 30b. Herein, the opening 30g represents an example of a second opening.

In order to ensure that the inside of the opening 30b is filled in a more reliable manner, the encapsulant 40 in the fluid state is poured in some extra quantity. Hence, sometimes the excess encapsulant 40 slightly overflows from the open end of the opening 30g. In case the thickness of the supporting member 30A increases due to the excess encapsulant 40, there is a risk that the size of the structure enclosing the supporting member 30A increases and in turn the size of the optical device 100A increases. In that case, there is a risk that only a limited space becomes available for installing the optical device 100. In that regard, in the first embodiment, since the open end of the opening 30g is adjacent to the notch 30f1 formed as a depression in the second supporting portion 30f, the excess amount of the encapsulant 40 in the fluid state can be collected in the notch 30f1 (the depression). As a result, it becomes possible to hold down an increase in the size of the structure enclosing the supporting member 30A due to the excess encapsulant 40, and in turn it becomes possible to hold down an increase in the size of the optical device 100A.

### First Covering Member

The first covering member 50 illustrated in FIGS. 2 and 3 is, for example, a tube made of synthetic resin such as elastomer. Thus, the first covering member 50 has flexibility and elasticity, and has a cylindrical shape extending in an annular cross-section. In the state of either remaining in contact with or being positioned with a gap from at least some portion of the outer surface of the optical fiber 20, the first covering member 50 encloses the optical fiber 20 over a section having a predetermined length.

The first covering member 50 is not glued to the optical fiber 20, and the inner surface of the first covering member 50 and the outer surface of the covering of the optical fiber 20 are kept slidable against each other. With such a configuration, when the optical fiber 20 is bent, it becomes possible to hold down an increase in the force acting from the first covering member 50 onto the optical fiber 20 due to the stiffening of the first covering member 50.

Moreover, as is clear from FIGS. 2 and 3, the first covering member 50 is positioned on the outside of the housing 10 as well as on the outside of the opening 30b of the supporting member 30A. More particularly, the first covering member 50 is positioned on the opposite side of the wall 11 of the housing 10 with reference to the end face 30d of the supporting member 30A, that is, is positioned toward the X direction with reference to the end face 30d; and is not housed inside the opening 30b of the supporting member 30A. In case the first covering member 50 is positioned inside the opening 30b, there is a risk that the diameter of the opening 30b increases proportionally and in turn the diameter of the supporting member 30A increases; and moreover there is a risk that the thickness of the optical device 100A increases in the surrounding portion of the supporting member 30A. In that case, there is a risk that only a limited space becomes available for installing the optical device 100A. In that regard, in the first embodiment, the first covering member 50 is positioned toward the X direction with reference to the end face 30d of the supporting member 30A and is not housed inside the opening 30b. For that reason, it becomes possible to hold down an increase in the size of the supporting member 30A, and in turn it becomes possible to hold down an increase in the size of the optical device 100A.

### Fixing Member

The fixing member 70 joins and integrates the supporting member 30 and the first covering member 50. The fixing member 70 is, for example, an adhesive made of synthetic resin. FIG. 5 is a cross-sectional view at V-V position illustrated in FIG. 3. As illustrated in FIGS. 2, 3, and 5, the fixing member 70 remains in contact with the periphery of the end portion of the first covering member 50 which is on the side close to the housing 10, that is, remains in contact with the periphery of the section close to the end portion of the first covering member 50 which is in the opposite direction to the X direction; and, in that state, encloses that periphery and is joined to the periphery. Moreover, as illustrated in FIGS. 2 and 3, the fixing member 70 remains in contact with the periphery of some portion of the outer surface 30a of the supporting member 30 on the side farther from the housing 10 and, in that state, encloses that periphery and is joined to the periphery. Thus, the supporting member 30 and the first covering member 50 are joined together via the fixing member 70. Because of the fixing member 70, the first covering member 50 can be held at a position away from the supporting member 30.

As illustrated in FIGS. 3 and 4, the fixing member 70 encloses the second supporting portion 30f of the supporting member 30. As explained earlier, in the supporting member 30A, the second supporting portion 30f has a smaller thickness than the first supporting portion 30e. With such a configuration, the portion of the fixing member 70 which encloses the supporting member 30A can be secured to have more thickness, thereby making it easier to secure the rigidity of the fixing member 70 and in turn making it easier to secure the bonding strength between the fixing member 70 and the supporting member 30A. Moreover, even when the encapsulant 40 that overflows from the opening 30g is present inside the notch 30f1 (the depression), it still becomes easier to secure the desired thickness of the fixing member 70 around the notch 30f1, and to secure the desired bonding strength.

Moreover, in the first embodiment, in the optical fiber 20, at the positions facing the end face 30d of the supporting member 30, there is a section not covered by the first covering member 50; and the fixing member 70 is joined to that section too. The fixing member 70 remains in contact with the periphery of some portion of the optical fiber 20 and, in that state, encloses that periphery and is joined to that periphery. That is, in the first embodiment, the supporting member 30, the first covering member 50, and the optical fiber 20 are joined and integrated via the fixing member 70.

The fixing member 70 representing an adhesive is applied, in the fluid state, around the periphery of the supporting member 30, the optical fiber 20, and the first covering member 50. Then, the fixing member 70 is solidified to a relatively harder state.

### Second Covering Member

As illustrated in FIGS. 3 and 5, the second covering member 60 remains in contact with at least some portion of the outer surfaces of the fixing member 70, the first covering member 50, and the supporting member 30; and, in that state, encloses at least some portion of the outer surfaces of the fixing member 70, the first covering member 50, and the supporting member 30. The second covering member 60 has flexibility and elasticity.

For example, the second covering member 60 is a heat shrink tube made of synthetic resin. Thus, upon being fitted to loosely enclose the fixing member 70, the first covering member 50, and the supporting member 30; the second covering member 60 shrinks due to heating and as a result tightly encloses the fixing member 70, the first covering member 50, and the supporting member 30, and is held by those members.

In the state in which the side of the first covering member 50 which is farther from the housing 10 is kept exposed, the second covering member 60 encloses some portion of the first covering member 50 that is on the side close to the housing 10.

The second covering member 60 covers at least some portion of the periphery of the fixing member 70. As a result, it becomes possible to hold down a situation in which the second covering member 60 comes off from the housing 10 because of the friction force with the fixing member 70. Moreover, in the first embodiment, the second covering member 60 encloses almost the entire fixing member 70, so that the fixing member 70 is not exposed. As a result, not only the protectivity of the fixing member 70 can be enhanced, but it also becomes possible to hold down the spoiling of the aesthetic appearance of the optical device 100 due to the exposure of the fixing member 70.

Moreover, the second covering member 60 either makes contact with the face 11a of the wall 11 of the housing 10 or extends close to the face 11a, and covers some portion of the supporting member 30 that is on the side close to the housing 10. As a result, not only the protectivity of the supporting member 30 can be enhanced, but it also becomes possible to hold down the spoiling of the aesthetic appearance of the optical device 100 due to the exposure of the supporting member 30. However, it is not necessary that the second covering member 60 covers the fixing member 70 and the supporting member 30.

The second covering member 60 is not glued to the fixing member 70, the first covering member 50, and the supporting member 30; and is held by the fixing member 70, the first covering member 50, and the supporting member 30 mainly due to the friction force. In this configuration, the second covering member 60 is disposed to sandwich the fixing member 70 in the longitudinal direction (the X direction). Hence, it becomes possible to hold down a situation in which the second covering member 60 comes off from the housing 10. On the other hand, the second covering member 60 and the first covering member 50 are kept slidable against each other. With such a configuration, when the optical fiber 20 is bent, it becomes possible to hold down an increase in the force acting from the second covering member 60 onto the first covering member 50 and in turn onto the optical fiber 20 due to the stiffening of the second covering member 60.

### Deformation Against Bending Input

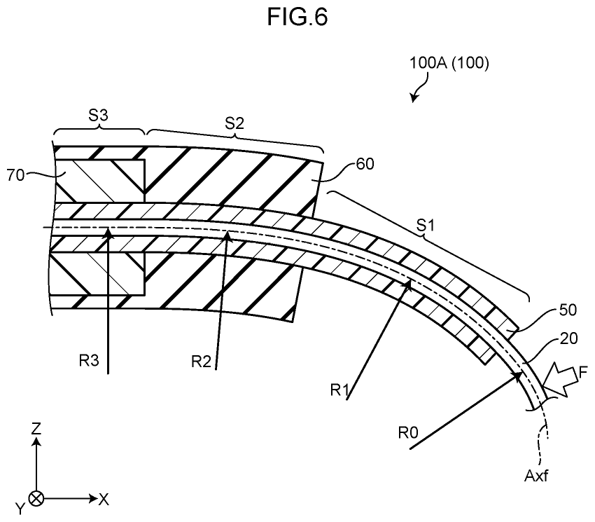

FIG. 6 is a cross-sectional view that, in the state in which the optical fiber 20 is bent due to the input of a bending input F to the optical fiber 20, illustrates some portion of the optical device 100A at the equivalent position to the position illustrated in FIG. 3. As illustrated in FIGS. 2, 3, and 6, due to the configuration explained above, in the optical device 100A, a first section S1, a second section S2, and a third section S3 are formed along the optical fiber 20 and away from the housing 10 and the supporting member 30A. In the first section S1, only the first covering member 50 encloses the covering of the optical fiber 20. The second section S2 is adjacent to the side close to the housing 10 and the supporting member 30A with reference to the first section S1. In the second section S2, only the first covering member 50 and the second covering member 60 enclose the optical fiber 20. The third section S3 is adjacent to the second section S2 on the opposite side of the first section S1. In the third section S3, the first covering member 50, the fixing member 70, and the second covering member 60 enclose the optical fiber 20. Meanwhile, it is not necessary for the second covering member 60 to enclose the optical fiber 20 over the entire third section S3.

As explained above, the first covering member 50 and the second covering member 60 have flexibility and elasticity. Hence, corresponding to the bending input F with respect to the totally uncovered portion of the optical fiber 20, the first covering member 50 and the second covering member 60 bend in response to the bending of the optical fiber 20. In that case, the first section S1 is covered only by the first covering member 50, and the second section S2 is covered by the first covering member 50 and the second covering member 60. Hence, as compared to the first section S1, the second section S2 is more difficult to bend. The third section S3 includes the fixing member 70 that is relatively harder, thereby making it more difficult to bend than the first section S1 and the second section S2. For example, corresponding to the bending input F at which the optical fiber 20 bends without breaking, the third section S3 is configured either to bend only slightly or to substantially not bend.

In that configuration, when the curved state of each section corresponding to the bending input F is compared with the radius of curvature of a central axis Axf of the optical fiber 20 (i.e., the radius of curvature at the plane parallel to the input direction of the bending input F), radii of curvature R0 in the uncovered exposed section of the optical fiber 20 (i.e., the section from the end portion of the first covering member 50 to the input point of the bending input F) have the smallest average value. The average value of radii of curvature R1 in the first section S1 becomes greater than the average value of the radii of curvature R0, and the average value of radii of curvature R2 in the second section S2 becomes greater than the average value of the radii of curvature R1. Moreover, radii of curvature R3 in the third section S3 have the greatest average value. That is, (average value of radii of curvature R3)>(average value of radii of curvature R2)>(average value of radii of curvature R1)>(average value of radii of curvature R0) holds true. Thus, with such a configuration, the radius of curvature of the optical fiber 20 can be gradually reduced from the third section S3 toward the second section S2, the first section S1, and the input point of the bending input F for the optical fiber 20. Hence, it becomes possible to hold down sudden bending of the optical fiber 20 with respect to the bending input F, and in turn it becomes possible to hold down the damage occurring to the optical fiber 20.

As described above, in the first embodiment, the optical device 100A includes the first section S1 in which only the first covering member 50 encloses the optical fiber 20, and includes the second section S2 which is adjacent to the side close to the supporting member 30A with reference to the first section S1 and in which only the first covering member 50 and the second covering member 60 enclose the optical fiber 20. As a result, corresponding to the bending input F applied to the optical fiber 20, it becomes possible to gradually increase the bending of the optical fiber 20 as the distance from the supporting member 30A increases. That enables holding down sudden bending of the optical fiber 20, and in turn enables holding down the damage occurring to the optical fiber 20. Moreover, the first covering member 50 is not housed in the opening 30b of the supporting member 30A, and is disposed outside the supporting member 30A. That enables holding down an increase in the size of the surrounding portion of the supporting member 30A, and in turn enables holding down an increase in the thickness of the optical device 100A. As a result, the optical device 100 can be configured in a more compact manner.

Meanwhile, in the first embodiment, the second supporting portion 30f is configured to be thinner or finer than the first supporting portion 30e in the Z direction. Herein, the Z direction can represent the normal direction of the mounting surface for the components such as the optical components, the electrical components, and the electronic components in the substrate housed in the housing 10. However, that is not the only possible case. Alternatively, the Z direction can be the direction in which the size of the surrounding portion of the supporting member 30, in turn, the size of the optical device 100 is restricted, or the direction in which it is preferable to trim the size. Thus, the Z direction can be an arbitrary direction intersecting with the X direction.

### Second Embodiment

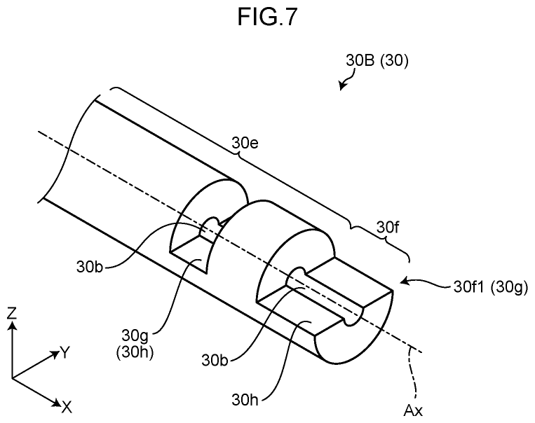

FIG. 7 is a perspective view of some portion of a supporting member 30B (30) according to a second embodiment. The supporting member 30B can be substituted for the supporting member 30A according to the first embodiment. In that case too, it becomes possible to achieve identical effects to the effects achieved according to the first embodiment.

As illustrated in FIG. 7, in the second embodiment, the second supporting portion 30f is configured to have the notch 30f1 (the depression) that is formed by cutting out the end portion of the supporting member 30B in the X direction in a semicircular shape within a section having a predetermined length in the X direction. The notch 30f1 has a face 30h that intersects with the Z direction, that is substantially orthogonal to the Z direction, and that is oriented in the Z direction. The notch 30f1 is connected to the opening 30b. The opening 30b is formed as a recessed groove on the face 30h.

The opening 30g that is connected to the opening 30b is formed not in the second supporting portion 30f but in the first supporting portion 30e. The opening 30g too is formed as a notch (a depression) formed by cutting out the first supporting portion 30e in a semicircular shape within a section having a predetermined length in the X direction. In that case, the opening 30g extends in a radial direction of the central axis Ax of the opening 30b, that is, in a direction intersecting with the axial direction (the X direction). The opening 30g too has the face 30h that intersects with the Z direction, that is substantially orthogonal to the Z direction, and that is oriented in the Z direction. In that portion too, the opening 30b is formed as a recessed groove on the face 30h. In the second embodiment, the notch 30f1 that is formed in the second supporting portion 30f represents one more opening 30g that is connected to the opening 30b.

With such a configuration, the encapsulant 40 (not illustrated in FIG. 7, refer to FIG. 3) can be poured into the opening 30b from the opening 30g or the notch 30f1. According to the second embodiment, the encapsulant 40 that overflows from the opening 30b can be retained in the opening 30g or the notch 30f1, and it becomes possible to hold down an increase in the size of the surrounding portion of the supporting member 30B due to the overflowing encapsulant 40, and in turn it becomes possible to hold down an increase in the thickness of the optical device that includes the supporting member 30B. That is, according to the second embodiment too, the optical device can be configured in a more compact manner.

### Third Embodiment

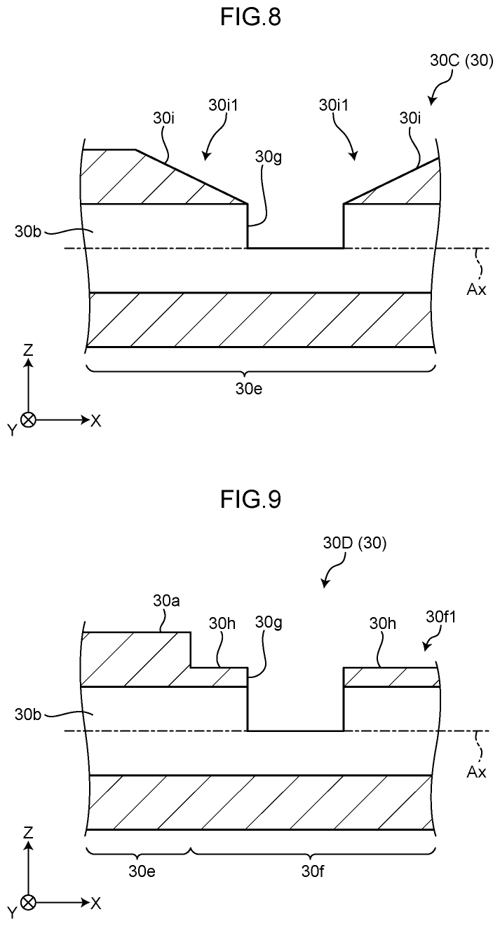

FIG. 8 is a cross-sectional view of a supporting member 30C (30) according to a third embodiment. The supporting member 30C can be substituted for the supporting member 30A according to the first embodiment. In that case too, it becomes possible to achieve identical effects to the effects achieved according to the first embodiment.

However, as illustrated in FIG. 8, according to the third embodiment, the opening 30g is formed in the first supporting portion 30e. The opening 30g is formed as a notch in an identical manner to the second embodiment. Meanwhile, the second supporting portion 30f (not illustrated in FIG. 8) can be configured to have the notch 30f1 (the depression) in an identical manner to the first embodiment or the second embodiment.

Moreover, in the first supporting portion 30e, an inclined face 30i is formed at the position adjacent to the opening 30g in the X direction as well as at the position adjacent to the opening 30g in the opposite direction to the X direction. Each inclined face 30i extends along the axial direction of the opening 30b (i.e., either in the X direction or the opposite direction to the X direction) and extends to approach the central axis Ax as the distance to the opening 30g decreases. In that case, due to each inclined face 30i, a space 30i1 gets formed adjacent to that open end of the opening 30g which is away from the central axis Ax. Meanwhile, the inclined faces 30i can be flat surfaces or can be curved surfaces such as concave surfaces. The inclined faces 30i represent examples of a first inclined face.

With such a configuration, the encapsulant 40 (not illustrated in FIG. 8, refer to FIG. 3) can be poured into the opening 30b from the opening 30g. According to the third embodiment, the encapsulant 40 that overflows from the opening 30g can be retained in the spaces 30i1, and it becomes possible to hold down an increase in the size of the surrounding portion of the supporting member 30C due to the overflowing encapsulant 40, and in turn it becomes possible to hold down an increase in the thickness of the optical device that includes the supporting member 30C. That is, according to the third embodiment too, the optical device can be configured in a more compact manner.

Meanwhile, the spaces 30i1 formed due to the inclined faces 30i can be said to be a part of the opening 30g. In that case, it can be said that the end portion of the opening 30g on the side farther from the central axis Ax is wider than the portion of the opening 30g that is closer to the central axis Ax than the end portion.

### Fourth Embodiment

FIG. 9 is a cross-sectional view of some portion of a supporting member 30D (30) according to a fourth embodiment. The supporting member 30D can be substituted for the supporting member 30A according to the first embodiment. In that case too, it becomes possible to achieve identical effects to the effects achieved according to the first embodiment.

As illustrated in FIG. 9, in the fourth embodiment, the opening 30g is formed in the second supporting portion 30f. The second supporting portion 30f is configured to have the notch 30f1 in an identical manner to the first embodiment. Moreover, the opening 30g is configured as a through hole extending in the Z direction in an identical manner to the first embodiment.

With such a configuration, the encapsulant 40 (not illustrated in FIG. 9, refer to FIG. 3) can be poured into the opening 30b from the opening 30g. According to the fourth embodiment, the encapsulant 40 that overflows from the opening 30g can be retained in the notch 30f1, and it becomes possible to hold down an increase in the size of the surrounding portion of the supporting member 30D due to the overflowing encapsulant 40, and in turn it becomes possible to hold down an increase in the thickness of the optical device that includes the supporting member 30D. That is, according to the fourth embodiment too, the optical device can be configured in a more compact manner.

### Fifth Embodiment

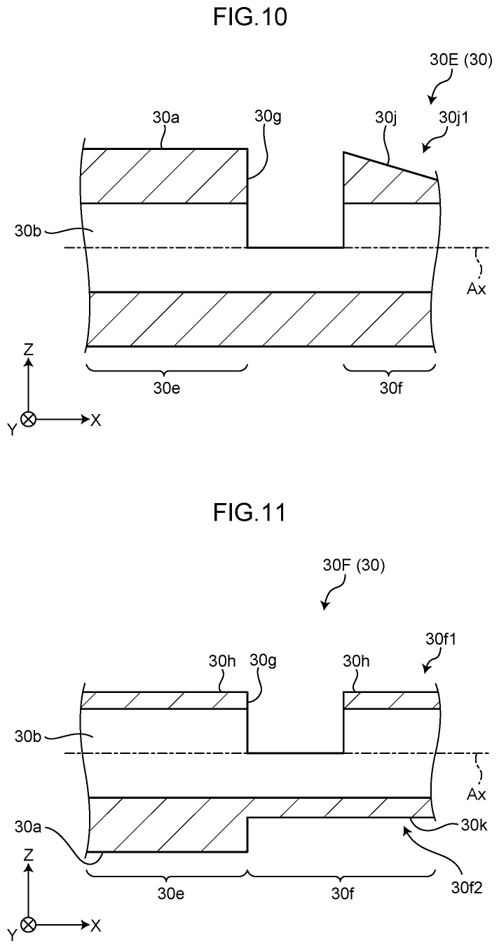

FIG. 10 is a cross-sectional view of some portion of a supporting member 30E (30) according to a fifth embodiment. The supporting member 30E can be substituted for the supporting member 30A according to the first embodiment. In that case too, it becomes possible to achieve identical effects to the effects achieved according to the first embodiment.

As illustrated in FIG. 10, in the fifth embodiment, the opening 30g is formed at the boundary between the first supporting portion 30e and the second supporting portion 30f. In the fifth embodiment, the second supporting portion 30f is configured to have an inclined face 30j that is adjacent to the opening 30g in the X direction. The inclined face 30j is inclined along the axial direction of the opening 30b (i.e., in the X direction) and extends to approach the central axis Ax as the distance from the opening 30g increases. Due to the inclined face 30j, as the distance from the opening 30g in the X direction increases, the second supporting portion 30f gradually becomes finer or thinner. For example, the inclined face 30j can be a flat surface extending in the Y direction, or can be a curved surface such as a surface of revolution around the central axis Ax. In the latter case, the inclined face 30j can also be referred to as a tapering surface. In that case, due to the inclined face 30j, a space 30j1 gets formed adjacent to that open end of the opening 30g which is away from the central axis Ax. Meanwhile, the inclined face 30j can be a flat surface or can be a curved surface such as a concave surface. The inclined face 30j represents an example of a second inclined face.

With such a configuration, the encapsulant 40 (not illustrated in FIG. 10, refer to FIG. 3) can be poured into the opening 30b from the opening 30g. According to the fifth embodiment, the encapsulant 40 that overflows from the opening 30g can be retained in the space 30j1, and it becomes possible to hold down an increase in the size of the surrounding portion of the supporting member 30E due to the overflowing encapsulant 40, and in turn it becomes possible to hold down an increase in the thickness of the optical device that includes the supporting member 30E. That is, according to the fifth embodiment too, the optical device can be configured in a more compact manner.

### Sixth Embodiment

FIG. 11 is a cross-sectional view of some portion of a supporting member 30F (30) according to a sixth embodiment. The supporting member 30F can be substituted for the supporting member 30A according to the first embodiment. In that case too, it becomes possible to achieve identical effects to the effects achieved according to the first embodiment.

As illustrated in FIG. 11, in the sixth embodiment, the opening 30g is formed in the second supporting portion 30f. Moreover, the notch 30f1 that is identical to the first embodiment is formed from the first supporting portion 30e to the second supporting portion 30f. Moreover, in the second supporting portion 30f, another notch 30f2 is formed that is different from the notch 30f1. The notch 30f1 is positioned at the end portion of the second supporting portion 30f in the Z direction, and the notch 30f2 is positioned at the end portion of the second supporting portion 30f in the opposite direction to the Z direction. The notch 30f1 has the face 30h that intersects with the Z direction, that is substantially orthogonal to the Z direction, and that is oriented in the Z direction. The notch 30f2 has a face 30k that intersects with the Z direction, that is substantially orthogonal to the Z direction, and that is oriented in the opposite direction to the Z direction.

With such a configuration, the encapsulant 40 (not illustrated in FIG. 11, refer to FIG. 3) can be poured into the opening 30b from the opening 30g. According to the sixth embodiment, the encapsulant 40 that overflows from the opening 30g can be retained in the notch 30f1, and it becomes possible to hold down an increase in the size of the surrounding portion of the supporting member 30F due to the overflowing encapsulant 40, and in turn it becomes possible to hold down an increase in the thickness of the optical device that includes the supporting member 30F. That is, according to the sixth embodiment too, the optical device can be configured in a more compact manner.

Moreover, in the sixth embodiment, the first supporting portion 30e as well as the second supporting portion 30f can be configured to be thinner or finer. Accordingly, the optical device can be configured in a still more compact manner.

### Seventh Embodiment

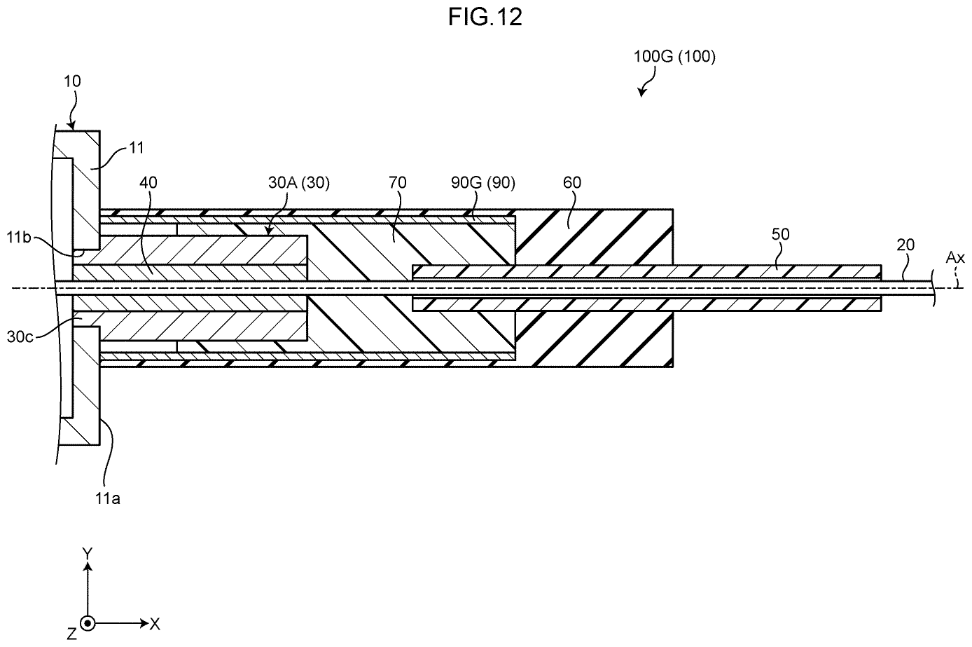

FIG. 12 is a cross-sectional view of an optical device 100G (100) according to a seventh embodiment at the equivalent position to the position illustrated in FIG. 2. As illustrated in FIG. 12, in the seventh embodiment, the optical device 100G includes an enclosure member 90G (90) that encloses the fixing member 70.

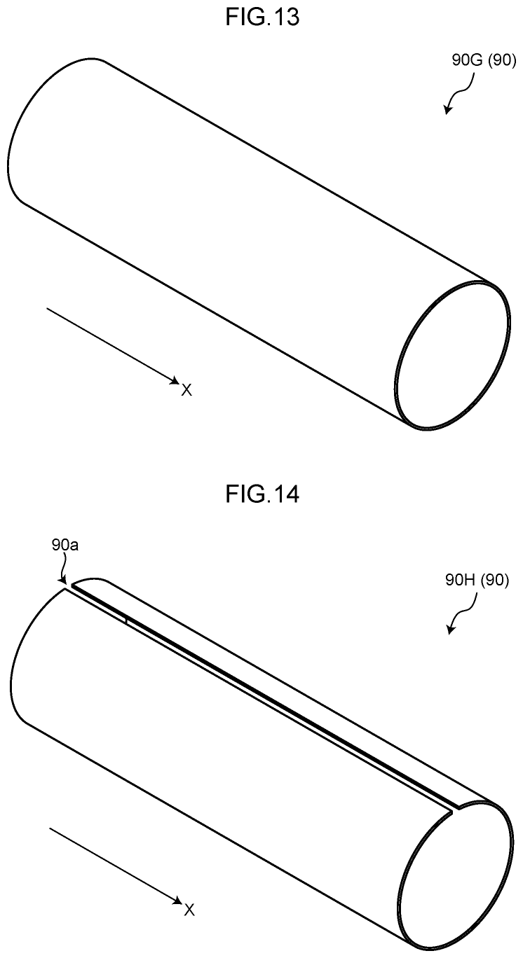

FIG. 13 is a perspective view of the enclosure member 90G. As illustrated in FIG. 13, the enclosure member 90G has a cylindrical shape with a relatively smaller thickness. For example, the enclosure member 90G has a higher elastic modulus than the fixing member 70, and can be made of a harder material such as a metal. More particularly, for example, the enclosure member 90G can be made of a steel material such as stainless steel, or a copper material such as a copper alloy, or an aluminum material such as an aluminum alloy. With such a configuration, the enclosure member 90G having a relatively simpler configuration can be disposed according to a relatively easier process. That enables achieving further enhancement in the rigidity and the strength of the structure enclosing the optical fiber 20. Moreover, the unevenness of the outer surface can be reduced as compared to the fixing member 70, thereby making it easier to manage the thickness and the diameter of the structure enclosing the optical fiber 20 and enabling achieving enhancement in the external appearance of the structure enclosing the optical fiber 20. Moreover, an opening such as a notch or a hole can be formed in the enclosure member 90G and the fixing member 70 in the fluid state can be poured from that opening, so that the enclosure member 90G can be used as the mold for the fixing member 70. In that case, the time and the cost required to provide the fixing member 70 can be further reduced. The enclosure member 90 can also be called a reinforcement member.

### Eighth and Ninth Embodiments

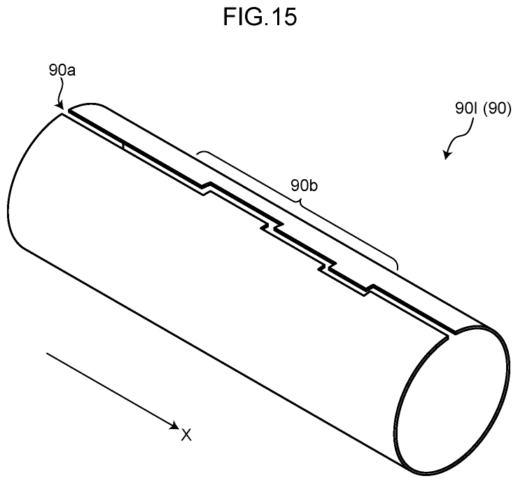

FIG. 14 is a perspective view of an enclosure member 90H (90) according to an eighth embodiment, and FIG. 15 is a perspective view of an enclosure member 90I (90) according to a ninth embodiment.

According to the seventh embodiment, the enclosure member 90G is a seamless pipe. According to the eighth and ninth embodiments, the enclosure members 90H and 90I are formed by bending a plank into a cylindrical shape. For that reason, the enclosure members 90H and 90I have a gap 90a (slit) extending in the X direction. Thus, with such a configuration, the enclosure member 90 can be formed using a plank. Moreover, according to the ninth embodiment (FIG. 15), at both end portions facing the gap 90a, recessed-projected structures 90b are formed that engage with each other in the X direction. That enables holding down a loss of the cylindrical shape of the enclosure member 90I due to the misalignment, in the X direction, of the end portions facing the gap 90a.

### 10-th Embodiment

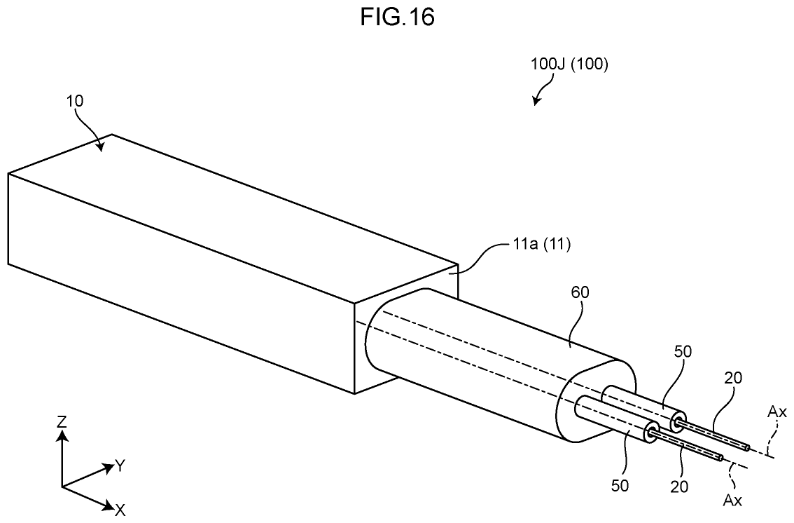

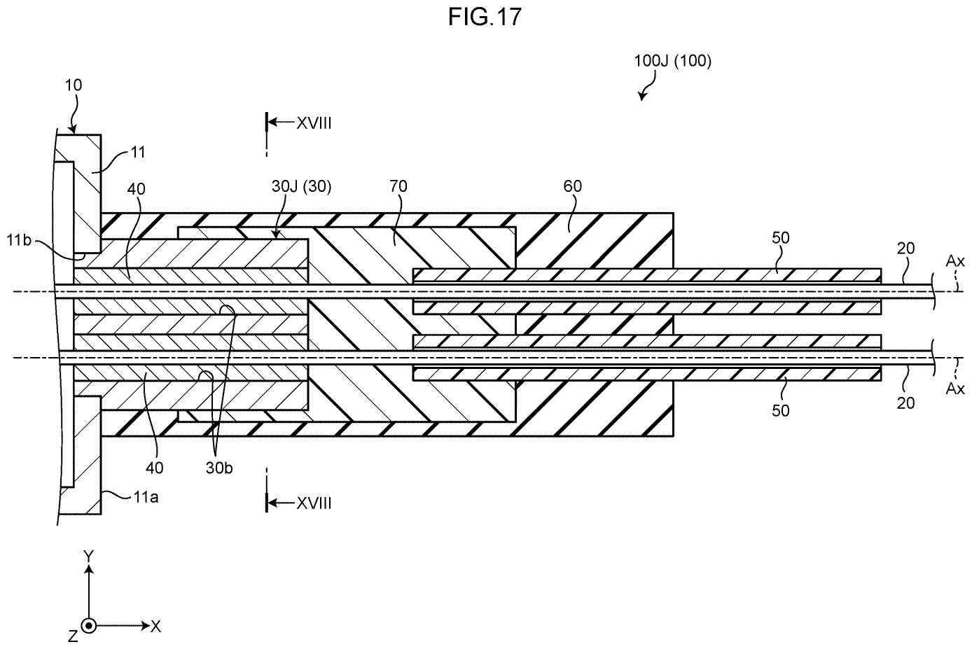

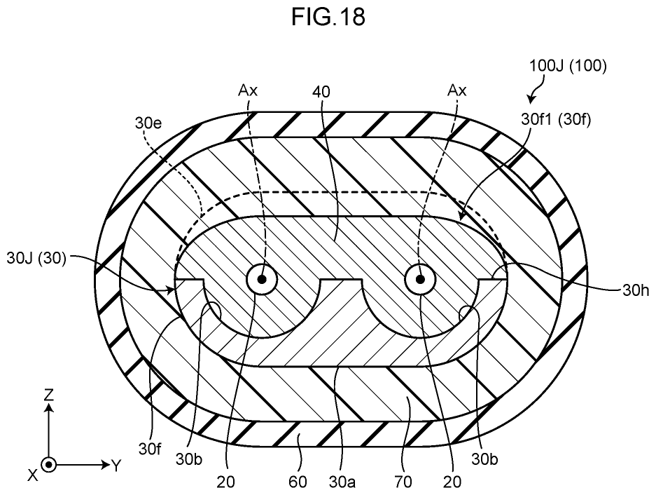

FIG. 16 is a perspective view of an optical device 100J (100) according to a 10-th embodiment. FIG. 17 is a cross-sectional view of the optical device 100J at the equivalent position to the position illustrated in FIG. 2. FIG. 18 is a cross-sectional view at XVIII-XVIII position illustrated in FIG. 17.

As illustrated in FIGS. 16 to 18, the optical device 100J includes a plurality of optical fibers 20. Moreover, as illustrated in FIGS. 17 and 18, in a supporting member 30J (30), a plurality of openings 30b is formed corresponding to the optical fibers 20. Each first covering member 50 encloses one optical fiber 20. The second covering member 60 encloses a plurality of first covering members 50. The fixing member 70 remains in contact with the supporting member 30J, the first covering members 50, the second covering member 60, and the optical fibers 20; and enables fixing the supporting member 30J, the first covering members 50, the second covering member 60, and the optical fibers 20. In this configuration, the opening 30b represents an example of a first opening, and the first covering members 50 represent examples of a first covering member.

As illustrated in FIG. 18, in the 10-th embodiment, as an example, the notch 30f1 formed in the second supporting portion 30f functions as the opening 30g. In that case, the opening 30g is connected to a plurality of openings 30b. However, the supporting member 30J is not limited to that configuration. Alternatively, the opening 30g (a second opening) can be formed corresponding to each opening 30b. The position of the opening 30g and the shape of the supporting member 30 can be modified in a variety of manner.

In this way, according to the 10-th embodiment, in the optical device 100J too in which a plurality of optical fibers 20 pass through the wall 11, it becomes possible to achieve identical effects to the effects achieved according to the embodiments described above. Moreover, in the 10-th embodiment, a single supporting member 30J, a single second covering member 60, and a single fixing member 70 can be disposed for a plurality of optical fiber 20. Hence, as compared to the configuration in which those components are individually disposed for each optical fiber 20, not only the number of components can be reduced, but the time and the cost required for manufacturing can also be reduced. Meanwhile, in the 10-th embodiment, two optical fibers 20 are included. However, that is not the only possible case, and there can be three or more optical fibers 20.

While certain embodiments and modification examples have been described, these embodiments and modification examples have been presented by way of example only, and are not intended to limit the scope of the disclosure. The accompanying claims and their equivalents are intended to cover such forms or modifications as would fall within the scope and spirit of the disclosure. Moreover, regarding the constituent elements, the specifications about the configurations and the shapes (structure, type, direction, shape, size, length, width, thickness, height, number, arrangement, position, material, etc.) can be suitably modified.

For example, the direction of extension of the second opening or the direction in which the notch (the depression) is facing can be set to various directions, such as the direction in which the thickness is to be held down. Moreover, the configurations explained in the embodiments described above can be applied in a variety of optical devices.

The enclosure member can be made of a material other than a metal, such as synthetic resin. Moreover, the enclosure member can be made of a transparent material. In that case, even when the optical fiber gets damaged in the section covered by the fixing member, the light leaking from the damaged portion can be visually confirmed from the outside of the enclosure member while the enclosure member is still in place. Alternatively, the enclosure member can be a heat shrink tube. In that case, the enclosure member can be disposed with more ease.

According to the present disclosure, it becomes possible to obtain a new and improved optical device that can be configured in a more compact manner.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical device comprising:
a housing;
an optical fiber that extends from inside of the housing to outside of the housing;
a supporting member that is integrated with the housing while protruding from the housing, and that has a first opening formed therein for allowing passage of the optical fiber;
an encapsulant that, inside the first opening of the supporting member, is present between the supporting member and the optical fiber;
a first covering member that, in state of either remaining in contact with or being positioned with a gap from at least some portion of a covering of the optical fiber on outside of the housing and outside of the first opening, encloses the optical fiber;
a second covering member that, while remaining in contact with the first covering member, encloses the first covering member; and
a fixing member that joins and integrates the supporting member and the first covering member, wherein
along the optical fiber, a first section is provided in which only the first covering member encloses the covering, and a second section is provided which is adjacent to side close to the supporting member with reference to the first section and in which only the first covering member and the second covering member enclose the optical fiber.

2. The optical device according to claim 1, wherein
the first section and the second section have flexibility,
the first section and the second section bend in response to a bending input applied to a portion that is on opposite side of the housing with reference to the first covering member of the optical fiber, and
average value of radii of curvature in the first section with respect to the bending input is smaller than average value of radii of curvature in the second section with respect to the bending input.

3. The optical device according to claim 2, wherein
a third section is provided which is adjacent to the second section on opposite side of the first section and in which at least the first covering member and the fixing member enclose the optical fiber, and
average value of radii of curvature in the third section in response to the bending input is greater than average value of radii of curvature in the second section in response to the bending input.

4. The optical device according to claim 1, wherein
the covering and the first covering member are slidable against each other, and
the first covering member and the second covering member are slidable against each other.

5. The optical device according to claim 1, wherein the second covering member covers at least some portion of periphery of the fixing member.

6. The optical device according to claim 5, wherein the second covering member covers the fixing member so that the fixing member is not exposed.

7. The optical device according to claim 1, wherein the fixing member joins and integrates the supporting member, the first covering member, and the optical fiber.

8. The optical device according to claim 1, further comprising an enclosure member that encloses the fixing member.

9. The optical device according to claim 1, wherein
the supporting member includes
a first supporting portion, and
a second supporting portion in which thickness in a direction intersecting with axial direction of central axis of the first opening is smaller than thickness of the first supporting portion, and
some portion of the fixing member encloses the second supporting portion.

10. The optical device according to claim 9, wherein, in the first supporting portion, a second opening is formed that is connected to the first opening and that extends at least in a direction intersecting with the axial direction.

11. The optical device according to claim 9, wherein, in the second supporting portion, a second opening is formed that is connected to the first opening and that extends at least in a direction intersecting with the axial direction.

12. The optical device according to claim 9, wherein, at boundary between the first supporting portion and the second supporting portion, a second opening is formed that is connected to the first opening and that extends at least in a direction intersecting with the axial direction.

13. The optical device according to claim 10, wherein an end portion of the second opening on side farther from the central axis is wider than a portion of the second opening that is closer to the central axis than the end portion.

14. The optical device according to claim 11, wherein an end portion of the second opening on side farther from the central axis is wider than a portion of the second opening that is closer to the central axis than the end portion.

15. The optical device according to claim 12, wherein an end portion of the second opening on side farther from the central axis is wider than a portion of the second opening that is closer to the central axis than the end portion.

16. The optical device according to claim 10, wherein, in the first supporting portion, a first inclined face is formed that, along the axial direction, is inclined toward the central axis as distance to the second opening decreases.

17. The optical device according to claim 12, wherein, in the second supporting portion, a second inclined face is formed that is adjacent to the second opening and that, along the axial direction, is inclined to toward the central axis as distance from the second opening increases.

18. The optical device according to claim 1, wherein
in the supporting member, as the first opening, a plurality of first opening portions each of which allows passage of the optical fiber is formed,
the first covering member includes a plurality of first covering portions each of which encloses the covering of the optical fiber on outside of the housing and outside of the first opening,
the second covering member encloses the plurality of first covering portions, and
the fixing member remains in contact with the supporting member, the plurality of first covering portions, and the second covering member, and fixes the supporting member, the plurality of first covering portions, and the second covering member.

19. The optical device according to claim 18, wherein, in the supporting member, a second opening is formed that is connected to the plurality of first opening portions and that extends in a direction intersecting with axial direction of central axis of the first opening.

20. The optical device according to claim 18, wherein, in the supporting member, a plurality of second opening portions is formed each of which is connected to one of the first opening portions and which extends in a direction intersecting with axial direction of central axis of the first opening.
